(19) United States
(12) Patent Application Publication
(10) Pub. No.: US 2004/0089340 A1
(43) Pub. Date: May 13, 2004

(54) Fuel cut-off valve device

(75) Inventors: Nobuharu Muto, Sashima-gun (JP); Hiroya Tagami, Sashima-gun (JP)

Correspondence Address: OLIFF & BERRIDGE, PLC, P.O. BOX 19928, ALEXANDRIA, VA, 22320, US

(73) Assignee: KYOSAN DENKI CO., LTD., IBARAKI-PREF (JP)

(21) Appl. No.: 10/691,579

(22) Filed: Oct. 24, 2003

(30) Foreign Application Priority Data
Oct. 28, 2002 (JP) 2002-312010

(51) Int. Cl. F16K 24/04

(52) U.S. Cl. 137/202

(57) ABSTRACT

In a fuel cut-off valve device including a casing, a float which is provided so as to be movable up-and-down in the casing, a valve element which is provided on a top surface of the float, a ventilation passage which is communicated with a downstream side of the valve element, at least one opening which is provided below the float and is positioned in the fuel tank, there is provided a plate whose diameter is larger than a diameter of the float and which is provided below the float.

### INCORPORATION BY REFERENCE

The disclosure of Japanese Patent Application No. 2002-312010 filed on Oct. 28, 2002 including the specification, drawings and abstract is incorporated herein by reference in its entirety.

### BACKGROUND OF THE INVENTION

1. Field of the Invention

The invention relates to a fuel cut-off valve device provided in a ventilation passage which allows communication between a fuel tank and a canister. More particularly, the invention relates to a fuel cut-off valve device which prevents a fuel cut-off valve from being closed too early due to air released from the fuel tank during fuel supply, and which prevents fuel from leaking to the ventilation passage due to a delay in closing a float valve immediately before the fuel tank is filled up.

2. Description of the Related Art

A fuel tank for storing fuel to be supplied to a combustion chamber of an engine is provided in an automobile or the like. A ventilation system is provided in the fuel tank such that air whose amount corresponds to an increase/decrease in an amount of the fuel in the tank can flow in/out. The ventilation system allows communication between the inside of the fuel tank and a canister. When the fuel tank is supplied with an excessive amount of fuel, part of the fuel is spilled, and the spilled fuel flows toward the canister. As a result, the canister becomes wet and unusable. Accordingly, a fuel cut-off valve device is provided in an upper portion of the fuel tank, and when the fuel tank is filled up, the fuel cut-off valve device blocks the ventilation system such that the air and the fuel do not flow toward the canister.

FIGS. 6 to 8 show a fuel cut-off valve device according to art related to the invention. A fuel tank 2 is mounted on an automobile, and the fuel to be supplied to an engine is stored in the fuel tank 2. A fuel cut-off valve device 1 is provided in an upper portion of the fuel tank 2. The fuel cut-off valve device 1 is coupled with a canister 5 through a ventilation passage 6. An oil filler pipe 3, which is closed by a filler cap 4, is coupled with the fuel tank 2, and fuel is supplied through the oil filler pipe 3 as required.

FIGS. 7 and 8 show the fuel cut-off valve device 1. As shown in FIG. 7, a communication opening 17 is formed in the upper portion of the fuel tank 2, and the fuel cut-off valve device 1 is provided in the communication opening 17. The fuel cut-off valve device 1 is provided with a casing 7, a float 12, a spring 14, and the like. The casing 7 is a case having a hollow cylindrical shape whose lower end is open, and a valve seat 15 is formed in an upper portion of the casing 7. Further, on an internal surface of the casing 7, a plurality of vertical ribs 18 is provided. The ribs 18 are provided at even intervals. The ribs 18 guide up-and-down movements of the float 12, and assists the fuel in flowing into the casing 7.

The float 12 is provided in the casing 7. After the float 12 is housed, a flange 10a, which is formed below the float 12 and which is formed integrally with an upper end of a pipe 10, is coupled with an open end of the casing 7 by welding or the like. An opening of the pipe 10 is positioned at the center of the flange 10a. The cylindrical spring 14 is provided around the opening so as to be positioned inside the float 12. The spring 14 does not have a spring force sufficient to push up the float 12 in a normal state. However, when the fuel flows into the casing 7, the spring 14 functions so as to assist the float 12 in moving upward.

A valve element 13 is provided on a top surface of the float 12. When the float 12 moves upward, the valve element 13 contacts the valve seat 15. When fuel is supplied through the oil filler pipe 3, a fuel level in the fuel tank 2 rises. When the fuel level reaches a lower end of the pipe 10 and continues rising, the fuel flows into the casing 7 through the opening of the pipe 10. The fuel then pushes up the float 12. When the fuel level reaches a predetermined position, the valve element 13 provided on the top surface of the float 12 contacts the valve seat 15. When the valve element 13 provided on the top surface of the float 12 contacts the valve seat 15, the ventilation passage 6 is closed. Accordingly, a pressure in the fuel tank 2 increases, and the fuel supply is stopped. The fuel level obtained at this time is a fill-up fuel level 16.

Next, a schematic configuration of a fuel cut-off valve device having a function similar to the above-mentioned device will be described with reference to FIG. 8. In the casing 7, there are provided the float 12, the valve element 13 and the valve seat 15 and the like which are the same as those in the fuel cut-off valve device in FIG. 7. These components have the same functions as those of the fuel cut-off valve device in FIG. 7. A major difference between the devices in FIG. 8 and FIG. 7 is that, in the device in FIG. 8, a bottom plate 9 is used as a member corresponding to a bottom plate of the casing 7 in the device in FIG. 7. The bottom plate 9 has a plurality of holes 11. The air and the fuel in the fuel tank 2 flow into the casing 7 through the holes 11. When the fuel tank is filled up, the valve element 13 contacts the valve seat. The fuel cut-off valve device having a configuration shown in FIG. 8 is disclosed, for example, in Japanese Patent Laid-Open Publication No. 11-37007.

In the fuel cut-off valve devices shown in FIGS. 7 and 8, the following two problems occur during fuel supply.

Hereafter, a first problem will be described. When fuel is supplied into the fuel tank 2, the air in the fuel tank 2 is released into the atmosphere through the fuel cut-off valve device 1, the ventilation passage 6, and the canister 5. The air in the fuel tank 2 flows into the casing 7 through the pipe 10 and the holes 11 which are the openings formed in a bottom portion of the casing 7. Since fuel is supplied into the fuel tank 2 rapidly, the air flows into the casing 7 rapidly. Accordingly, the air which has flowed into the casing 7 acts so as to push up the float 12. In the worst case, a problem occurs that the valve is closed too early, that is, the valve element 13 provided on the top surface of the float 12 contacts the valve seat 15 and the ventilation passage 6 is closed during fuel supply. The problem causes a further problem that the fuel supply is stopped while fuel is being supplied.

Next, a second problem will be described. When the fuel supply to the fuel tank 2 is continued, the amount of the fuel in the tank 2 increases. Immediately before the fuel tank 2 is filled up, the fuel reaches the pipe 10 and the holes 11 which are the openings of the fuel cut-off valve device 1, and flows into the casing 7 through the pipe 10 and the holes 11. As mentioned above, since the fuel supply to the fuel tank 2 is performed rapidly, the fuel flows into the casing 7 rapidly. The fuel acts so as to push up the float 12. However, since the fuel flows into the casing 7 and the fuel level rises rapidly, the float 12 cannot move in accordance with the rise of the fuel. Therefore, a problem occurs that the valve is closed too late, that is the valve element 13 provided on the top surface of the float 12 contacts the valve seat 15 and the ventilation passage 6 is closed after the fuel moves upward. The problem causes a further problem that part of the fuel flows into the canister 5 through the ventilation passage 6 immediately before the fuel tank is filled up.

### SUMMARY OF THE INVENTION

It is an object of the invention to prevent a fuel cut-off valve from being closed too early during fuel supply to the fuel tank and the fuel supply to being stopped while the fuel is being supplied, and the fuel from flowing toward a canister.

In order to attain at least part of the above-mentioned objects, a fuel cut-off valve device according to a first aspect of the invention includes a casing; a float which is provided so as to be movable up-and-down in the casing; a valve element which is provided on a top surface of the float; a ventilation passage which is communicated with a downstream side of the valve element; at least one opening which is provided below the float and is positioned in the fuel tank; and a plate whose size is larger than a size of the float and which is provided below the float.

According to the first aspect, since the air and the fuel do not contact an undersurface of the float directly, there is no possibility that the ventilation passage is closed due to the air during fuel supply, or part of the fuel is released to the canister side. Accordingly, fuel supply to the fuel tank can be performed without hindrance. Also, even when air is mixed in the fuel, the air is separated from the fuel when the fuel contacts the plate.

In the first aspect, the plate may be extended so as to surround the lower portion of the float. The plate may be attached to the casing by snap fit. The plate may be provided with a protruding portion on an undersurface thereof. The plate may also serve as a spring bearing.

A fuel cut-off valve device according to a second aspect of the invention is provided with a casing having a valve opening which communicates with a ventilation passage provided in a downstream side of the fuel cut-off valve device in an upper portion; a float which is provided so as to be movable up-and-down in the casing; a valve element which is provided on a top surface of the float and which closes the valve opening when the float moves upward; an opening which is provided in the lower portion of the float and which allows communication between the inside of the casing and the inside of the fuel tank; and a member which is provided between the float and the opening, is independent of the float, and contacts the air and the fuel that flow into the casing through the opening.

### BRIEF DESCRIPTION OF THE DRAWINGS

FIG. 1 is a sectional view showing a fuel cut-off valve device according to an embodiment of the invention;

FIG. 2 is a sectional view showing a fuel cut-off valve device according to another embodiment of the invention;

FIG. 3 is a sectional view of main portions, showing a plate of a fuel cut-off valve device according to a further embodiment;

FIG. 4 is a sectional view of main portions, showing a plate of a fuel cut-off valve device according to a further embodiment;

FIG. 5 is a sectional view of main portions, showing a plate of a fuel cut-off valve device according to a further embodiment;

FIG. 6 is a diagram schematically showing a fuel cut-off valve device attached to a fuel tank;

FIG. 7 is a sectional view showing a fuel cut-off valve device according to art related to the invention; and

FIG. 8 is a sectional view showing a conventional fuel cut-off valve device according to another embodiment of art related to the invention.

### DETAILED DESCRIPTION OF THE PREFERRED EMBODIMENTS

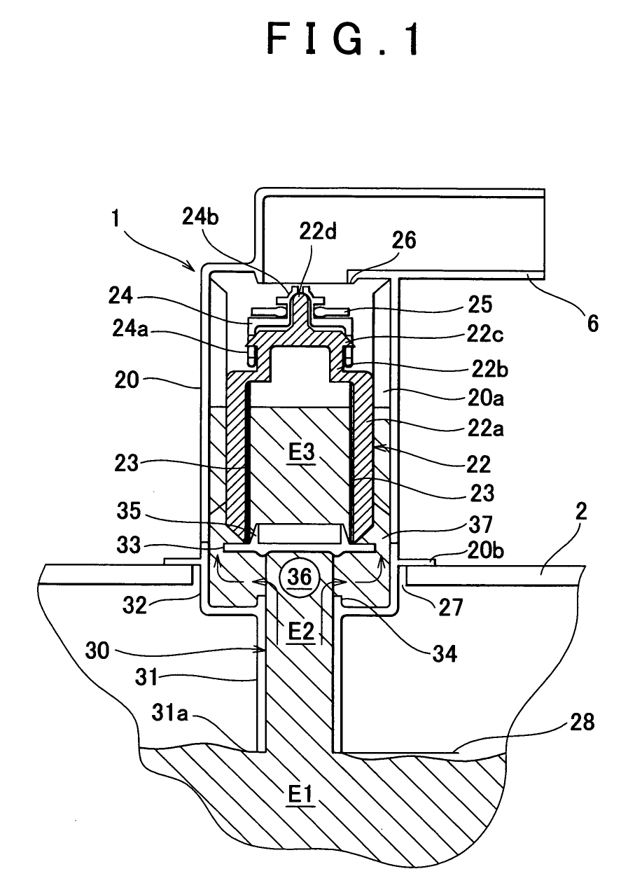

A fuel cut-off valve device 1 according to a first embodiment will be described with reference to FIG. 1. A communication opening 27 is provided in an upper portion of a fuel tank 2, and the fuel cut-off valve device 1 is provided in the communication opening 27. The fuel tank 2 is made of resin. The fuel cut-off valve device 1 is integrally coupled with the upper portion of the fuel tank 2 by welding or the like. The fuel tank 2 may be made of metal. In this case, the fuel cut-off valve device 1 is integrally coupled with the fuel tank 2 with screws or the like.

The fuel cut-off valve device 1 is provided on the upper portion of the fuel tank 2, and is provided with a casing 20, a float 22, a spring 23 and the like. The casing 20 is made of resin, and has a hollow cylindrical shape whose lower end is open. A valve seat 26 is formed on an internal top surface of the casing 20, and a ventilation passage 6 is provided in a downstream side of the valve seat 26. Also, a plurality of vertical ribs 20a is formed on an internal side surface of the casing 20. The ribs 20a are provided at even intervals, and guide the up-and-down movements of the float 22. A flange 20b is provided integrally with the periphery of the casing 20, and the casing 20 is attached to the fuel tank 2 through the flange 20b.

Below the lower end portion of the casing 20, there is provided a pipe 30 formed integrally with the plate 33. When the pipe 30 is provided below the lower end portion of the casing 20, the float 22, the spring 23 and the like are housed in the casing 20. After these members are housed in the casing 20, the spring 23, which is provided on the top surface of a plate 33 so as to be positioned inside the internal surface of the float 22, assists the float 22 in moving upward. The spring force of the spring 23 is not sufficient to push up the float 22 in a normal state. However, when the fuel flows into the casing 20, the spring force acts as a force added to the force applied to the float 22, and pushes up the float 22 promptly.

The float 22 is made of resin and has a substantially hollow cylindrical shape whose lower end is open. The float 22 has a lower portion formed of a large cylindrical portion 22a, and an upper portion formed of a small cylindrical portion 22b. The external surface of the large cylindrical portion 22a is configured so as to contact the vertical ribs 20a provided on the internal surface of the casing 20. The large cylindrical portion 22a moves up-and-down along the ribs 20a. On the external surface of the small cylindrical portion 22b, there is provided a plurality of engagement pieces 22c which protrude in a diametrical direction of the float 22. A protruding portion 22d is provided at the center of the top surface of the small cylindrical portion 22b.

A valve element 24 is provided on the small cylindrical portion 22b of the float 22. The valve element 24 is made of resin, and has a substantially hollow cylindrical shape whose lower end is open. On the side surface, there is provided a plurality of engagement grooves 24a which can be engaged with a plurality of the engagement pieces 22c formed on the external surface of the small cylindrical portion 22b of the float 22. At the center of the top surface, there is provided a hollow protruding portion 24b into which the protruding portion 22d on the small cylindrical portion 22b of the float 22 is inserted.

The float 22 and the valve element 24 are attached to each other in the following manner. The valve element 24 is placed on the upper portion of the float 22. In this state, a force is applied to the upper portion of the valve element 24, and the valve element 24 is made to move downward. Then, the valve element 24 is pushed down along the external surface of the small cylindrical portion 22b of the float 22. As a result, the engagement pieces 22c provided on the external surface of the small cylindrical portion 22b of the float 22 enter the engagement grooves 24a of the valve element 24, and the float 22 and the valve element 24 are engaged with each other. Consequently, the valve element 24 is coupled with the float 22. The valve element 24 and the float 22 are supported at one portion between the protruding portion 22d of the float 22 and the hollow protruding portion 24b of the valve element 24. Accordingly, the valve element 24 can inclined using the supporting portion as a pivot.

A circular packing 25 is provided on the top surface of the valve element 24 so as to be engaged with the hollow protruding portion 24b. When the float 22 moves upward, the packing 25 contacts the valve seat 26 formed on the internal top surface of the casing 20, and prevents the air and the fuel from flowing toward the ventilation passage 6. In this case, since the valve element 24 can be inclined using the supporting portion as a pivot, even when the float 22 is inclined, the packing 25 and the valve element 26 can contact each other appropriately.

Below the lower portion of the casing 20, there is provided the pipe 30 formed integrally with the plate 33 which is a main portion of the invention. The pipe 30 is made of resin, and is provided with a hollow circular pipe portion 31, a cup-shaped flange 32 formed above the circular pipe portion 31, a plate 33 formed above the center of the flange 32, and a ring-shaped positioning protrusion 35 protruding from the top surface of the plate 33.

The hollow circular pipe portion 31 of the pipe 30 is provided below the communication opening 27 provided in the upper portion of the fuel tank 2 so as to be positioned inside the fuel tank 2. The fill-up fuel level 28 in the fuel tank 2 is decided using a tip portion 31a of the circular pipe portion 31. The cup-shaped flange 32 formed above the pipe 30 is provided so as to contact the top surface of the fuel tank 2. When the fuel tank 2 is made of resin, the top surface of the fuel tank 2 and the undersurface of the flange 32 are welded such that the fuel tank 2 and the flange 32 are coupled with each other firmly. The lower end surface of the casing 20 is placed on the upper end portion of the flange 32 which curves in an upward direction, and the flange 32 and the casing 20 are integrally coupled with each other by hot welding, an adhesive agent or the like.

A cylindrical portion 34 having a shape obtained by extending the circular pipe portion 31 is formed on the top surface of the flange 32. The horizontal and circular plate 33 is formed integrally with the upper end of the cylindrical portion 34, and the positioning protrusion 35 for positioning the spring 23 is formed on the top surface of the plate 33. The diameter of the plate 33 is smaller than the diameter of the casing 20 and larger than the external diameter of the float 22. A clearance 37 is thus formed between the end of the plate 33 and the internal surface of the casing 20. The air and the fuel flowing into the casing 20 through the clearance 37 flow along the external surface of the float 22 toward the ventilation passage 6 which is in the downstream side. A plurality of the communication holes 36 is formed in the cylindrical portion 34, and the air and the fuel flowing in through the circular pipe portion 31 flow toward the clearance 37 through the communication holes 36.

According to such a configuration, as shown by the arrows, the air and the fuel flowing into the casing 20 from the fuel tank 2 through the pipe 30 contact the undersurface of the plate 33 directly, change directions, flow into the casing 20 through the communication holes 36 formed in the cylindrical portion 34 and the clearance 37, and flow toward the ventilation passage 6.

The effects of the fuel cut-off valve device 1 according to the invention will be described. When fuel is supplied through an oil filler pipe 3 shown in FIG. 6 to the fuel tank 2 to which the fuel cut-off valve device 1 is attached, the air in the fuel tank 2 is released to the ventilation passage 6 by the fuel cut-off valve device 1, and the fuel vapor contained in the air is adsorbed by the canister 5. In this case, the air mixed with the fuel flowing into the casing 20 through the pipe 30 contacts the plate 33, is separated into liquid and vapor, and flows along the internal surface of the casing 20 through the clearance 37 so as to move upward. As a result, the float 22 is prevented from being pushed up due to the flow of the air, and consequently, the valve seat 26 is prevented from being closed by the valve element 24 while fuel is being supplied.

Next, the fuel level in the fuel in the fuel tank 2 rises in accordance with an increase of the air released from the fuel tank 2, and consequently reaches the fill-up fuel level 28. Then, the tip portion 31a of the pipe 30 is blocked by a fuel E1, and the release of the air through the pipe 30 is stopped. The pressure in the fuel tank then increases, and the fuel E1 rapidly flows into the pipe 30 as a fuel E2. Then, the fuel E2 which has flowed into the pipe 30 contacts the plate 33 directly, and the fuel flowing force is reduced. The fuel E2 changes the direction so as to flow horizontally, and flows into the casing 20 through the clearance 37 as a fuel E3. As a result, the float 22 moves upward in accordance with the amount of the fuel flowing into the casing 20. Accordingly, the fuel E3 is prevented from flowing into the ventilation passage 6 before the float 22 moves upward.

The fuel E2 which has contacted the plate 33 flows into the casing 20 as the fuel E3, and pushes up the float 22. When a predetermined amount of the fuel E3 flows into the casing 20, the float 22 moves such that the packing 25 of the valve element 24 provided on the upper portion of the float 22 contacts the valve seat 26, and the fuel level of the fuel E3 is maintained at the position. The pressure in the fuel tank 2 further increases, and consequently, fuel supply is automatically stopped.

The air and the fuel flowing into the casing 20 from the fuel tank through the pipe 30 do not contact the float 22 directly. Accordingly, there is no possibility that the valve element 24 is closed during fuel supply or part of the fuel flows into the ventilation passage 6 before the valve element 24 is closed. The plate 33 is provided between the communication holes 36 and the float 22, covers at least the undersurface of the float 22, and is positioned and shaped such that the air and the fuel flowing into the casing 20 from the fuel tank contact the plate 33. Also, the plate 33 has a function of reducing the forces of the air and the fuel, which are applied to the float.

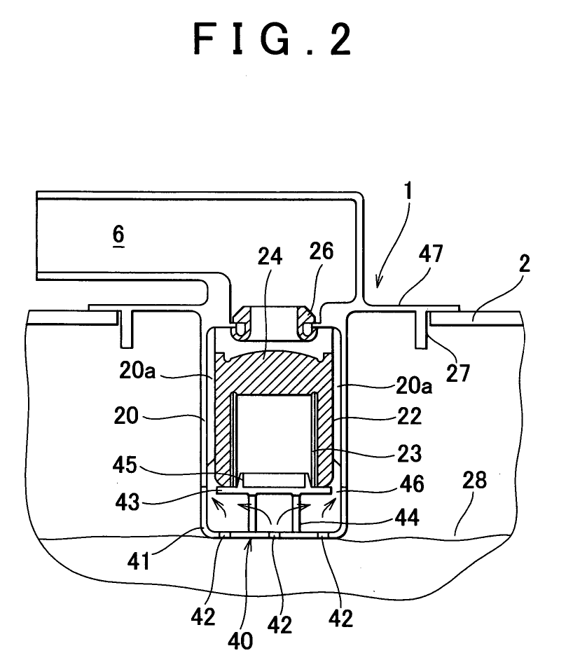

Next, the fuel cut-off valve device 1 according to a second embodiment of the invention will be described with reference to FIG. 2. Note that the same numbers will be assigned to the same portions as those of the first embodiment.

The communication opening 27 is formed in the upper portion of the fuel tank 2, and the fuel cut-off valve device 1 is provided in the communication opening 27. The fuel tank 2 is made of resin, and the fuel cut-off valve device 1 is coupled integrally with the upper portion of the fuel tank by welding or the like.

The fuel cut-off valve device 1 is provided from the upper portion of the fuel tank 2 so as to be positioned inside the fuel tank 2, and is provided with the casing 20, the float 22, the spring 23 and the like. The casing 20 is made of resin, and has a hollow cylindrical shape whose lower end is open. The valve seat 26 is formed on an internal top surface of the upper portion of the casing 20, and the ventilation passage 6 is provided in the downstream side of the valve seat 26. On the external surface of upper portion of the casing 20, a flange 47 which protrudes in the diametrical direction is formed. The undersurface of the flange 47 is placed on the top surface of the fuel tank 2 such that the flange 47 and the fuel tank 2 are integrally coupled with each other by welding or the like. In addition, on the internal surface of the casing 20, a plurality of vertical ribs 20a is provided. The ribs 20a are provided at even intervals, and guide the up-and-down movements of the float 22.

A bottom plate member 40 formed integrally with a plate 43 is attached to the lower end portion of the casing 20. When the bottom plate member 40 is attached to the lower end portion of the casing 20, the float 22, the spring 23 and the like are housed in the casing 20. After theses members are housed in the casing 20, the spring 23 is provided on the top surface of the plate 43 so as to be along the internal surface of the float 22, and assists the float 22 in moving upward. The spring force of the spring 23 is not sufficient to push up the float 22 in the normal state. However, when the fuel flows into the casing 20, the spring force acts as a force added to the force applied to the float 22 and pushes up the float 22 promptly.

The float 22 is made of resin and has a substantially hollow cylindrical shape whose lower end is open. The tip portion of the float 22 forms the valve element 24. When the valve element 24 contacts the valve seat 26, communication between the inside of the casing 20 and the ventilation passage 6 is interrupted.

The bottom plate member 40 formed integrally with the plate 43 is attached to the lower portion of the casing 20. The bottom plate member 40 is made of resin, and is provided with a cup-shaped bottom plate 41, the circular plate 43 formed above the center of the bottom plate 41 through columnar bodies 44, and a ring-shaped positioning protrusion 45 which protrudes from the top surface of the plate 43.

The lower end surface of the casing 20 is placed on the upper end portion of the cup-shaped bottom plate 41, and the bottom plate 41 and the casing 20 are integrally coupled with each other by hot welding, an adhesive agent or the like. Then, a space for housing the float is formed in the casing 20. A plurality of openings 42 is formed in the bottom plate 41, and the air and the fuel in the fuel tank 2 flow into the casing 20 through the openings 42.

A plurality of columnar bodies 44 is provided on the top surface of the bottom plate 41. The columnar bodies 44 are provided at even intervals, and the circular plate 43 is formed integrally with the tip portions of the columnar bodies 44, such that the plate 43 is positioned horizontally. Further, on the top surface of the plate 43, a positioning protrusion 45 for positioning the spring 23 is formed. The diameter of the plate 43 is smaller than the diameter of the casing 20, and larger than the external diameter of the float 22. A clearance 46 is thus formed between the end of the plate 43 and the internal surface of the casing 20. The air and the fuel flowing into the casing 20 through the clearance flow along the external surface of the float 22 toward the ventilation passage 6 that is in the downstream side.

According to such a configuration, as shown by the arrows, the air and the fuel flowing into the casing 20 from the fuel tank 2 through the opening 42 contact the undersurface of the plate 43, change directions, flow into the casing 20 through the clearance 46, and flow toward the valve element 24.

The effects of the fuel cut-off valve device according to the invention will be described. When fuel is supplied through the oil filler pipe 3 shown in FIG. 6 to the fuel tank 2 to which the fuel cut-off valve device 1 is attached, the air in the fuel tank 2 is released to the ventilation passage 6 by the fuel cut-off valve device 1, and the fuel vapor contained in the air is adsorbed by the canister 5. In this case, the air mixed with the fuel flowing into the casing 20 through the opening 42 of the bottom plate 41 contacts the plate 43, is separated into liquid and vapor, and flows along the internal surface of the casing 20 through the clearance 46 so as to move upward. As a result, the float 22 is prevented from being pushed up due to the flow of the air. Accordingly, the valve seat 26 is prevented from being closed by the valve element 24 during fuel supply.

Next, the fuel level in the fuel tank 2 rises in accordance with an increase in the air released from the fuel tank 2, and finally reaches the fill-up fuel level 28. Then, the opening 42 of the bottom plate 41 is blocked by the fuel, and the release of the air through the opening 42 is stopped. The pressure in the fuel tank 2 then increases, and the fuel flows into the casing 20 rapidly, as described in the first embodiment. Next, the fuel which has flowed into the casing 20 contacts the plate 43 directly, and the fuel flowing force is reduced. The fuel changes directions so as to flow horizontally, and flows into the casing 20 through the clearance 46. As a result, the float 22 moves upward in accordance with the amount of the fuel flowing into the casing 20. Therefore, there is no possibility that the fuel flows into the ventilation passage 6 before the float 22 moves upward.

The fuel which has contacted the plate 43 flows into the casing 20 through the clearance 46, and pushes up the float 22. When a predetermined amount of the fuel flows into the casing 20, the float 22 moves upward, the valve element 24 formed on the upper portion of the float 22 contacts the valve seat 26, and the fuel level of the fuel is maintained at the position. Then, the pressure in the fuel tank 2 further increases, and finally the fuel supply is automatically stopped.

The air and the fuel which flow into the casing 20 from the fuel tank 2 through the opening 42 of the bottom plate 41 and the clearance 46 do not contact the float 22 directly. Accordingly, there is no possibility that the valve element 24 is closed during fuel supply or part of the fuel flows into the ventilation passage 6 before the valve element 24 is closed. The plate 43 is provided between the opening 42 and the float 22, covers at least the undersurface of the float 22, and is positioned and formed so as to contact the air and the fuel flowing into the casing 20 from the fuel tank. The plate 43 has a function of reducing the forces of the air and the fuel, which are applied to the float.

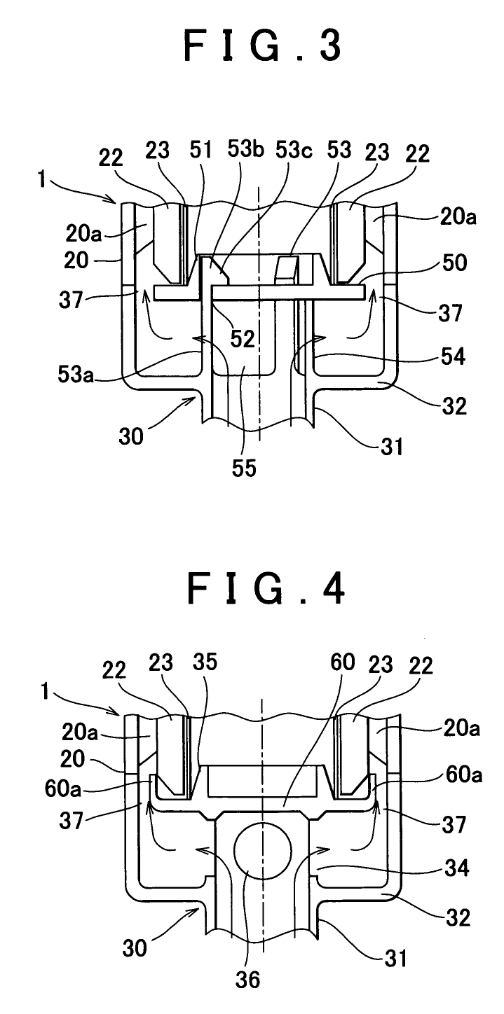

Next, the fuel cut-off valve device 1 according to a third embodiment of the invention will be described with reference to FIG. 3. The fuel cut-off valve device 1 is provided on the fuel tank which is the same as that in the first embodiment. FIG. 3 shows main portions in the vicinity of the plate. The other configurations are the same as those in FIG. 1, and the descriptions thereof will be omitted.

The difference between the fuel cut-off valve device in FIG. 3 and the fuel cut-off valve device in FIG. 1 is that the plate is provided as an independent body. On the upper end of the circular pipe portion 31 of the pipe 30, the cup-shaped flange 32 which is the same as that in FIG. 1 is formed. On the top surface of the center of the flange 32, there is provided engagement means 53 having a shape obtained by extending the circular pipe portion 31. Plural engagement means 53 are provided on the periphery at even intervals, and communication passages 55 are formed between the engagement means 53 next to each other. The engagement means 53 is provided with a shaft portion 53a which serves as a column, and an engagement portion 53b formed at the top of the shaft portion 53a. A protruding portion 53c which protrudes inwardly is provided on the engagement portion 53b. Further, supporting bodies 54 for supporting the after-mentioned plate at a predetermined position are provided between the engagement means 53 next to each other.

A plate 50 is formed independently of the engagement means 53. The plate 50 is a circular plate body. A positioning protrusion 51 for positioning the spring 23 is formed on the top surface of the plate 50. Further, on the internal side of the positioning protrusion 51, there is provided a plurality of holes 52. The engagement portions 53b formed on the upper portion of the engagement means 53 are inserted through the holes 52. The diameter of the plate 50 is smaller than the diameter of the casing 20, and lager than the external diameter of the float 22. A clearance 37 is thus formed between the end of the plate 50 and the internal surface of the casing 20. The air and the fuel flowing into the casing 20 through the clearance 37 flow along the external surface of the float 22 into the ventilation passage 6 which is in the downstream side, as shown by the arrows.

The plate 50 and the engagement means 53 are attached to each other in the following manner. The plate 50 is placed above the engagement means 53, the hole 52 of the plate 50 is aligned with the engagement portion 53b of the engagement means 53, the plate 53 is pushed down, and the engagement portion 53b of the engagement means 53 is inserted into the hole 52 of the plate 50. When the plate 50 is further pushed down, the protruding portion 53c of the engagement portion 53b protrudes above the hole 52 of the plate 50, and is engaged on the top surface of the plate 50. The plate 50 is attached to the casing 20 by snap fit. At this time, the undersurface of the plate 50 contacts the upper end portions of the plural supporting bodies 54 provided between the shaft portions 53a of the engagement means 53, and does not move downward from the position.

After the plate 50 and the engagement means 53 are attached to each other, a plurality of communication passages 55 are formed between the plate 50 and the engagement means 53, and the air and the fuel flowing in through the pipe 30 flow toward the clearance 37 through the communication passages 55.

According to such a configuration, as shown by the arrows, the air and the fuel flowing in from the fuel tank 2 through the pipe 30 contact the undersurface of the plate 50, change directions, flow into the casing 20 through a plurality of communication passages 55 formed between the shaft portions 53a of the engagement means 53 and the clearance 37, and flow toward the ventilation passage 6.

As a result, the air and the fuel flowing into the casing 20 from the fuel tank 2 through the pipe 30 do not contact the float 22 directly. Accordingly, there is no possibility that the valve element 24 is closed during fuel supply or part of the fuel flows into the ventilation passage 6 before the valve element 24 is closed. In the embodiment, the fuel cut-off valve device having a pipe is described. However, the fuel cut-off valve device including the bottom plate member having a plurality of openings may be employed, such as the fuel cut-off valve device according to the second embodiment.

Next, the fuel cut-off valve device 1 according to a fourth embodiment will be described with reference to FIG. 4. The fuel cut-off valve device 1 is provided on the fuel tank which is the same as that in the first embodiment in FIG. 1. FIG. 4 shows the main portions in the vicinity of the plate. The difference between the fuel cut-off valve device in FIG. 4 and the fuel cut-off valve device in FIG. 1 is that an extended portion is provided in the plate of the fuel cut-off valve device 1 in FIG. 4. The other configurations are the same as those in FIG. 1, and descriptions thereof will be omitted.

The cup-shaped flange 32 is formed on the upper end of the circular pipe portion 31 of the pipe 30, as in the case of the device in FIG. 1. On the top surface of the center of the flange 32, the cylindrical portion 34 having a shape obtained by extending the circular pipe portion 31 is formed. On the upper end of the cylindrical portion 34, a horizontal and circular plate 60 is integrally formed. The end of the plate 60 is extended and an extended portion 60a is formed. The extended portion 60a is formed by bending the end of the plate 60 approximately 90° angle upward such that the extended portion 60a surrounds the lower end portion of the float 22. The surface of the extended portion 60a is formed in a smooth arc-shape. The air and the fuel flow smoothly along the surface of the extended portion 60a. The diameter of the plate 60 is smaller than the diameter of the casing 20, and larger than the external diameter of the float 22. The clearance 37 is thus formed between the external surface of the extended portion 60a of the plate 60 and the internal surface of the casing 20. The air and the fuel flowing in through the clearance 37 flow along the external surface of the float 22 toward the ventilation passage 6 which is in the downstream side. Further, a plurality of the communication holes 36 is provided in the cylindrical portion 34, and the air and the fuel flowing in through the pipe 30 flow toward the clearance 37.

According to such a configuration, as shown by the arrows, the air and the fuel flowing in from the fuel tank 2 through the pipe 30 contact the undersurface of the plate 60, change directions, flow into the casing 20 through a plurality of the communication holes 36 formed in the cylindrical portion 34 and the clearance 37, and flow toward the ventilation passage 6.

As a result, the air and the fuel flowing into the casing 20 from the fuel tank 2 through the pipe 30 do not contact the float 22 directly. Accordingly, there is no possibility that the valve element 24 is closed during fuel supply, or part of the fuel flows into the ventilation passage 6 before the valve element 24 is closed. In the embodiment, the fuel cut-off valve device having a pipe is described. However, the fuel cut-off valve device including the bottom plate member having a plurality of openings may be employed, such as the device in the second embodiment.

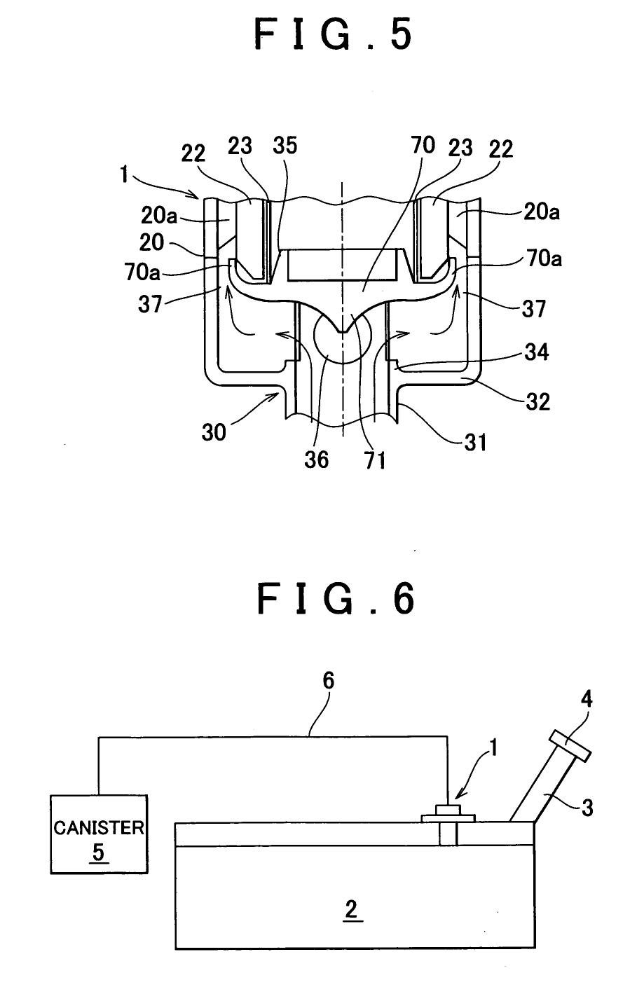

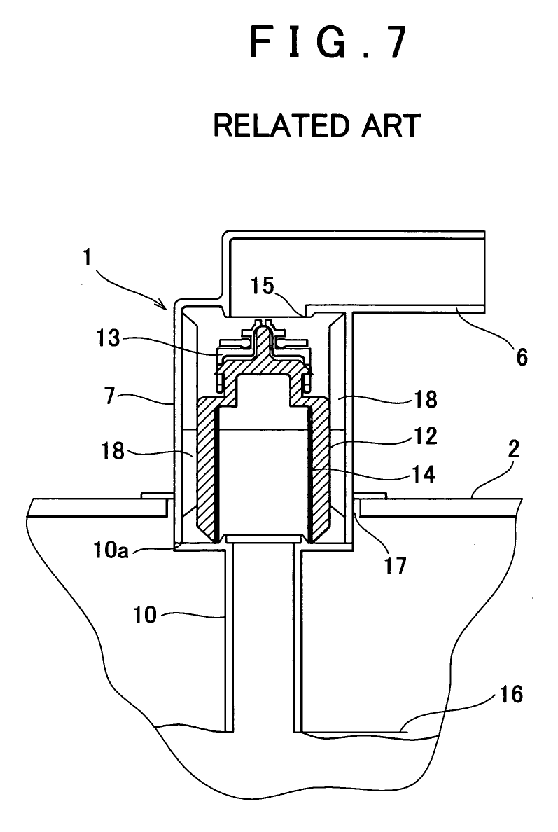

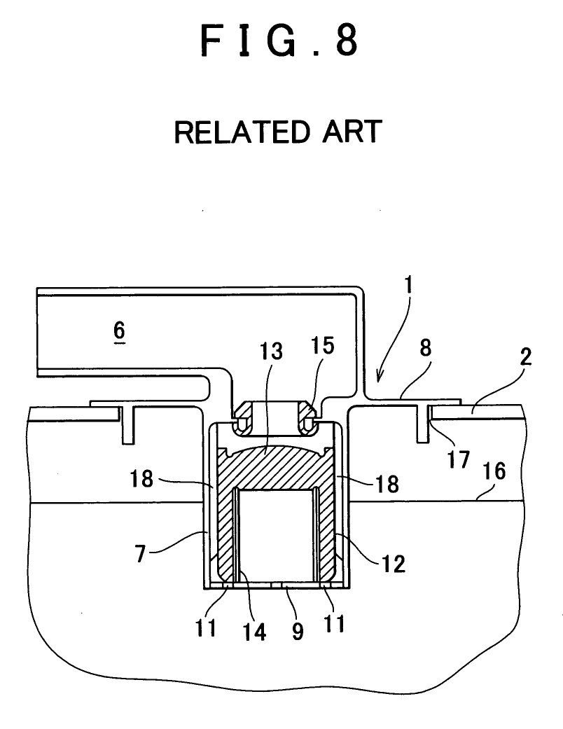

Next, the fuel cut-off valve device 1 according to a fifth embodiment will be described with reference to FIG. 5. The fuel cut-off valve device 1 is provided on the fuel tank which is the same as that in the first embodiment in FIG. 1. FIG. 5 shows the main portions in the vicinity of the plate. The configurations other than that the extended portion is provided on the plate and the protruding portion is further provided on the undersurface of the plate are the same as those in the FIG. 1. The configurations other than the main portion are the same as those in FIG. 1, and the descriptions thereof will be omitted. The difference between the fuel cut-off valve device in FIG. 5 and the fuel cut-off valve device in FIG. 1 is that the extended portion is provided on the plate and a protruding portion is further provided on the undersurface of the plate of the fuel cut-off valve device 1 in FIG. 5. The other configurations are the same as those in FIG. 1, and descriptions thereof will be omitted.

The cup-shaped flange 32 is formed on the upper end of the circular pipe portion 31 of the pipe 30. On the top surface of the center of the flange 32, the cylindrical portion 34 having a shape obtained by extending the circular pipe portion 31 is formed. On the upper end of the cylindrical portion 34, a horizontal and circular plate 70 is integrally formed. The end of the plate 70 is extended, and an extended portion 70a is formed. The extended portion 70a is formed by bending the end of the plate 70 approximately 90° angle upward such that the extended portion 70a surrounds the lower end portion of the float 22. The surface of the extended portion 70a is formed in a smooth arc-shape. The air and the fuel flow smoothly along the surface of the extended portion 70a. On the substantially center portion of the undersurface of the plate 70, a protruding portion 71 having a shape of an inverted triangle is formed. The tip of the protruding portion 71 has an arc-shape. The surface of the protruding portion 71 is gently curved toward the extended portion 70a. The protruding portion 71 is formed such that the flow of the fluid flowing along the surface thereof does not become turbulent.

The diameter of the plate 70 is smaller than the diameter of the casing 20, and larger than the external diameter of the float 22. The clearance 37 is thus formed between the external surface of the extended portion 70a of the plate 70 and the internal surface of the casing 20. The air and the fuel flowing in through the clearance 37 flow along the external surface of the float 22 toward the ventilation passage 6 which is in the downstream side. In addition, a plurality of the communication holes 36 is provided in the cylindrical portion 34, and the air and the fuel flowing in through the pipe 30 flow toward the clearance 37 through the communication holes 36.

According to such a configuration, the air and the fuel flowing in from the fuel tank 2 through the pipe 30 contact the undersurface of the plate 70, as shown by the arrows. However, the undersurface has the protruding portion 71 having a shape of an inverted triangle. Accordingly, the air and the fuel which have contacted the undersurface flow smoothly along the surface of the protruding portion 71. Therefore, the air and the fuel flow without a large pressure loss. The air and the fuel flow into the casing 20 through a plurality of the communication holes 36 formed in the cylindrical portion 34 and the clearance 37, and flows toward the communication passage 6.

As a result, the air and the fuel flowing into the casing 20 from the fuel tank 2 through the pipe 30 do not contact the float 22 directly. Accordingly, there is no possibility that the valve element 24 is closed during fuel supply or part of the fuel flows to the ventilation passage 6 before the valve element 24 is closed. In the embodiment, the fuel cut-off valve device having a pipe is described. However, the fuel cut-off valve device including the bottom plate member having a plurality of openings may be employed, such as the device in the second embodiment.

The invention is not limited to the above-mentioned embodiments. The embodiment may be realized in various other embodiments within the scope of the invention.

In the first to fifth embodiments, since a plate whose diameter is larger than that of the float is provided below the float, the air and the fuel from the fuel tank do not contact the undersurface of the float directly. Accordingly, the ventilation passage is prevented from being closed due to the air during fuel supply, and the fuel supply is prevented from being stopped while the fuel is being supplied. Also, there is no possibility that part of the fuel is released to the canister side.

In the fourth and fifth embodiments, since the plate is extended to so as to surround the lower portion of the float, the air and the fuel flowing from the fuel tank do not contact the undersurface of the float and the side surface of the lower portion. Accordingly, the ventilation passage is prevented from being closed due to the air during fuel supply, and the fuel supply can be prevented from being stopped while the fuel is being supplied, with higher reliability. Also, there is no possibility that part of the fuel is released to the canister side.

Generally, it is difficult to form the plate integrally with the casing since the form is complicated. However, in the third embodiment, the plate can be formed independently, since the plate is attached to the casing by snap fit. Accordingly, the manufacturing process becomes easier. Even when the plate has a complicated shape, the plate can be easily attached to the casing. Therefore, it is possible to provide flexibility to the design of the plate. In addition, it is not necessary to provide the hole through which the air and the fuel flow, and forming the plate becomes easier.

In the fifth embodiment, since a protruding portion is provided on the undersurface of the plate, it is possible to prevent the problem that the air which has contacted the plate becomes a turbulent flow and the pressure loss increases, and consequently the air is difficult to release.

In the first to fifth embodiment, since the plate also serves as a spring bearing, the number of the parts can be reduced. Also, the cost in production can be reduced.

What is claimed is:

1. A fuel cut-off valve device, comprising:
a casing;
a float which is provided so as to be movable up-and-down in the casing;
a valve element which is provided on a top surface of the float;
a ventilation passage which is communicated with a downstream side of the valve element;
at least one opening which is provided below the float and is positioned in the fuel tank, which allows communicates between an inside of the fuel tank and an inside of the casing; and
a plate whose size in a horizontal direction is larger than one of the float and which is provided between the at least one opening and the float.

2. The fuel cut-off valve device according to claim 1, wherein
a diameter of the plate is larger than a diameter of the float.

3. The fuel cut-off valve device according to claim 1, wherein
the plate is extended so as to surround the lower portion of the float.

4. The fuel cut-off valve device according to claim 1, wherein
the plate is attached to the casing by snap fit.

5. The fuel cut-off valve device according to claim 1, wherein
the plate is provided with a protruding portion on an undersurface thereof.

6. The fuel cut-off valve device according to claim 1, wherein
the plate also serves as a spring bearing.

7. A fuel cut-off valve device, comprising:
a casing having a valve opening which communicates with a ventilation passage provided in a downstream side of the fuel cut-off valve device in an upper portion of the casing;
a float which is provided so as to be movable up-and-down in the casing;
a valve element which is provided on a top surface of the float and which closes the valve opening when the float moves upward;
an opening which is provided in the lower portion of the float and which allows communication between an inside of the casing and an inside of the fuel tank; and
a member which is provided between the float and the opening, is independent of the float, and covers at least an entire undersurface of the float.

8. The fuel cut-off valve device according to claim 7, wherein
the member contacts air and fuel which has flowed into the casing through the opening.

9. The fuel cut-off valve device according to claim 7, wherein
the member has a flat plate, and a clearance is formed between an external end of the member and an internal surface of the casing.

10. The fuel cut-off valve device according to claim 7, wherein
the float has a cylindrical shape, the member has a circular flat plate and an external diameter of the member is larger than an external diameter of the cylinder.

11. The fuel cut-off valve device according to claim 7 further comprising:
a spring which is provided between the float and the member, and supplies an urging force to the float.
